(19) United States
(12) Patent Application Publication
(10) Pub. No.: US 2004/0195313 A1
(43) Pub. Date: Oct. 7, 2004

(54) Method for registering network information in mobile terminal using smart card

(76) Inventor: Hyeok-Soo Lee, Ichon-shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/750,239

(22) Filed: Dec. 31, 2003

(30) Foreign Application Priority Data
Apr. 4, 2003 (KR) 2003-21439

(51) Int. Cl. G06K 5/00

(52) U.S. Cl. 235/380

(57) ABSTRACT

Disclosed is a method for registering network information in a mobile terminal using a smart card. The method includes the steps of: receiving system network set-up information into a mobile terminal from a wireless communication system; connecting a smart card in the mobile terminal and determining if there exists network set-up information in the smart card; storing the newly-acquired network set-up information in a network set-up information file stored in the smart card if there is no network set-up information present in the smart card; and comparing the existing network set-up information stored in the smart card with the newly-acquired system network set-up information obtained from a wireless communication system and updating difference between the existing network set-up information and the newly-acquired system network set-up information in the network set-up information file if there is the network set-up information present in the smart card.

### FIELD OF THE INVENTION

The present invention relates to a method for registering network information in a mobile terminal using a smart card and, more particularly, to a method for registering network information in a mobile terminal using a smart card wherein the network information stored in a network set-up information file, which is a predetermined storage space for storing predetermined network set-up information, in a smart card

### DESCRIPTION OF RELATED ART

Hereinafter, a mobile terminal referred to all portable terminals capable of mobile communication, such as a Personal Communication Services (PCS) terminal, Personal Digital Assistant (PDA), Smart phone and next generation International Mobile Telecommunication (IMT-2000) terminal.

An Integrated Circuit (IC) card usage comes in a many varieties including usages in communications, finance, transportation and e-business. The IC card is increasingly commonplace nowadays largely due to a surge in the usage of the Internet as well as a favorable change in the information communication industry. With the emerging semi-conductor and software technologies, the IC card is capable of recording large amount of information without any security breaches, unlike in existing magnetic cards. The IC cards are categorized into a memory card and a smart card according to their functionality. The only and one purpose of memory card is to store data, whereas the smart card is more like a computer in miniature as it has a built-in logic circuit and a Central Processing Unit (CPU).

The smart card has a wide range of usages including applications in an IC card, a chip card, a micro processor card and a CPU card. The smart card can be thought of as a plastic card similar in size to a credit card, the plastic card with a built-in IC chip capable of handling a particular transaction. In general, such smart card has the following components in place, namely a micro-processor, an operating system, a security module and a memory. The typical smart card is similar in size to a credit card and is often small enough to be inserted into the mobile terminal.

The smart cards can be categorized into two groups according to their ways of communicating with the outside. One is a touch-type card with a contact surface plated with gold, the touch-type card to be plugged into the slot of a terminal. The other one is a non-touch-type card with a built-in antenna sending out a radio frequency (RF) signal to communicate. The smart card does not have a built-in power source, e.g., a battery, but otherwise the supply of electricity to the smart card comes from a reader. The use of Electrically Erasable Programmable Read Only Memory (EEPROM) makes certain that data kept in the memory is not lost in the event of a power outage. Strictly speaking, a memory card as such cannot be thought of as a smart card in that the memory card has no micro-processor. The memory card is equipped with nothing but memory itself.

The smart card includes a processor, a memory, an Input/Output (I/O) device, a Chip Operating System (COS) and application software. Nowadays, an 8-bit processor is widely in use, but it will soon be superseded by a 32-bit processor. In the memory are stored security keys, data, application services, protocols and cryptographic algorithms. The size of the memory can increase from as little as few bytes to the order of ten thousand bytes. The operational speed and capacity of the memory is on the increase.

On the other hand, the smart card module currently used in the mobile terminal includes a Subscriber Identity Module (SIM), User Identity Module (UIM) and Universal Subscriber Identity Module (USIM). The SIM is a ISO7816-type smart card module, intended for use in mobile communication network authentication when plugged into an European style mobile phones. The SIM is capable of handling non-volatile data, e.g., a telephone number, a mobile communication service provider and a private phone book. The SIM can handle a limited cipher functions and the running of some software. Information stored in the SIM card of the mobile communication terminal contains a telephone number, a private security key and data needed by the mobile terminal to successfully operate. Using the SIM, the existing information stored in the SIM card can be easily ported to another mobile terminal by means of simply plugging the SIM card in. In addition, security features are put in place in the SIM card. The SIM card can be used as a direct-debit card, a credit card and a travel pass. The GSM service providers have been leading the way in research on the SIM card which is emerging as a major money-making platform with which any futuristic data services can be used.

The UIM is an ISO7816-type smart card module capable of embracing a roaming service in the GSM network when inserted into the multi-modes of the CDMA and GSM terminals. A UIM card is a CDMA-type SIM card. The USIM is an ISO7816-type smart card module, intended for use in mobile communication network authentication when plugged into the third generation mobile communication terminal. The USIM is an industry standard and is recommended to have at least 64 KB EEPROM.

One major drawback to the conventional methods of making a record of network information in the mobile terminal is that existing information stored in the flash memory in one mobile terminal can not be ported to the other mobile terminal when a user switches or purchase mobile terminals, resulting in which the network information needs to be set up all over again. As is usually the case in technologies known in the prior art, additional network information such as an IP address from a wireless communication system or a user cannot be stored or updated other than those preset by a vendor. To put it simply, there isn't any defined area for updating newly received network information from the user or the wireless communication system and also there isn't enough storage space for additional network information in the conventional UIM or SIM. The system network information includes a Wireless Application Protocol (WAP) gateway address, Internet Protocol (IP) address, Domain Name Service (DNS) server address, WAP access point name, Multimedia Messaging Service (MMS) access point name and Internet access point name.

### SUMMARY OF THE INVENTION

It is, therefore, an object of the present invention to provide a method for registering network information in a mobile terminal using a smart card wherein the network information stored in a network set-up information file, which is a predetermined storage space for storing predetermined network set-up information, in a smart card.

In accordance with an aspect of the present invention, there is provided a method for registering network information in a mobile terminal using a smart card, the method including the steps of: a) receiving system network set-up information into a mobile terminal from a wireless communication system; b) connecting a smart card in the mobile terminal and determining if there exists network set-up information in the smart card; c) storing the newly-acquired network set-up information in a network set-up information file stored in the smart card if there is no network set-up information present in the smart card; and d) comparing the existing network set-up information stored in the smart card with the newly-acquired system network set-up information obtained from a wireless communication system and updating difference between the existing network set-up information and the newly-acquired system network set-up information in the network set-up information file if there is the network set-up information present in the smart card.

In accordance with another aspect of the present invention, there is provided a method for registering network information in a mobile terminal using a smart card, the method including the steps of: a) receiving personal network set-up information entered by a user; b) connecting to a smart card and determining if there exists network set-up information in the smart card; c) storing the newly-acquired network set-up information in the network set-up information file stored in the smart card if there is no network set-up information present in the smart card; and d) comparing the existing network set-up information stored in the smart card with the newly-acquired personal network set-up information inputted by a user and updating differences between the existing network set-up information and the newly-acquired personal network set-up information if there is network set-up information present in the smart card.

### BRIEF DESCRIPTION OF THE DRAWINGS

The above and other objects and features of the present invention will become apparent from the following description of the preferred embodiments given in conjunction with the accompanying drawings, in which:

FIG. 1 is a perspective view of a smart card in accordance with a preferred embodiment of the present invention;

FIG. 2 is a flow chart describing a method for registering system network information in a mobile terminal using a smart card in accordance with a preferred embodiment of the present invention;

FIG. 3 is a flow chart illustrating a method for registering personal network information in a mobile terminal using a smart card in accordance with another preferred embodiment of the present invention; and

FIG. 4 is a diagram showing a network related set-up for the network information registration method in a mobile terminal in accordance with a preferred embodiment of the present invention.

### DETAILED DESCRIPTION OF THE INVENTION

Other objects and aspects of the invention will become apparent from the following description of the embodiments with reference to the accompanying drawings, which is set forth hereinafter.

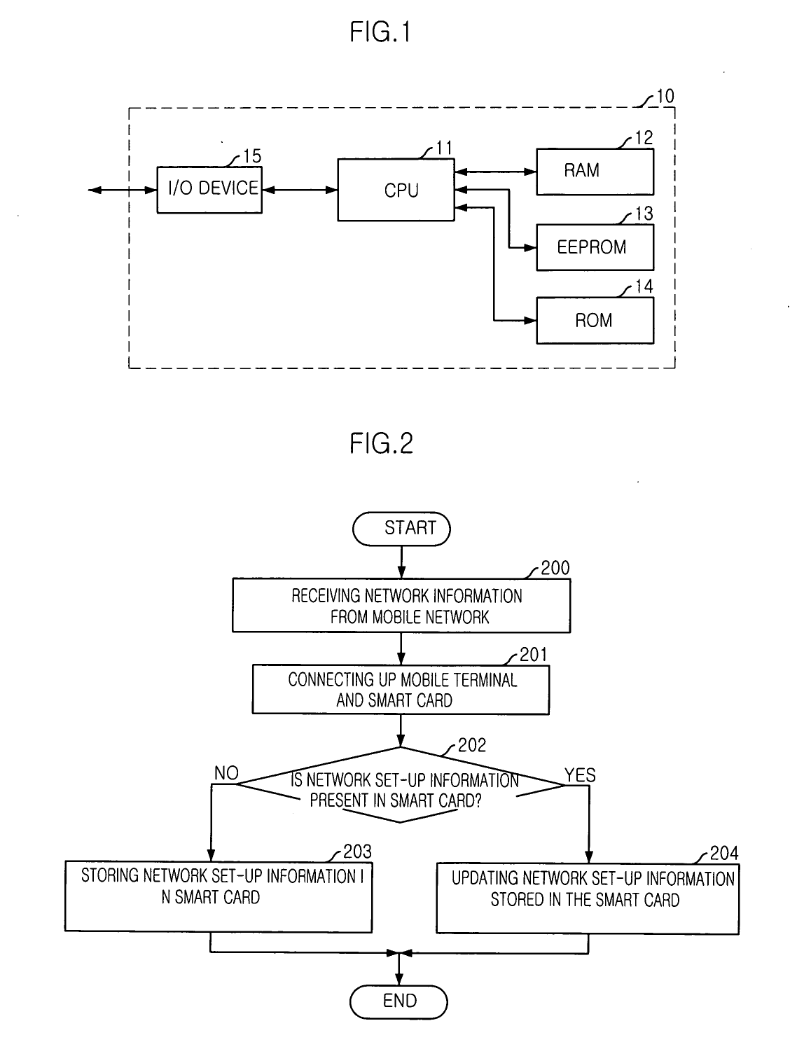

FIG. 1 is a perspective view of a smart card in accordance with a preferred embodiment of the present invention.

Referring to FIG. 1, included in the smart card are a Central Processing Unit (CPU) 11, a Random Access Memory (RAM) 12, an Electrically Erasable Programmable Read Only Memory (EEPROM) 13, a Random Only Memory (ROM) 14 and an Input/Output (I/O) device 15.

The CPU 11 decodes and performs the instructions of an application program. The RAM 12 keeps data in current use as well as data being produced as the program runs. The RAM 12 also stores the program in current use. The Electrically Erasable Programmable Read Only Memory (EEPROM) 13 stores security keys, data, application services, protocols and cryptographic algorithms. The Random Only Memory (ROM) 14 stores non-volatile data such as the operating system. The Input/Output (I/O) device 15 sends out data, clock, signal report and suchlike to a mobile communication terminal or vice versa.

FIG. 2 is a flow chart describing a method for registering system network information in a mobile terminal using a smart card in accordance with a preferred embodiment of the present invention.

At step S200, a mobile network receives s system network set-up information from a wireless communication system. At step S201, the mobile terminal connects to the smart card. At step S202, the mobile terminal determines if there exists network set-up information in the smart card. At step S203, the mobile terminal stores the newly-acquired network set-up information from the wireless communication system in a network set-up information file, which is a predetermined storage space for storing predetermined network set-up information, in the smart card if there is no network set-up information present in the network set-up information file in the smart card. The network set-up information file contains a service provider network related set-up Elementary File (EF) and a personal network related set-up EF.

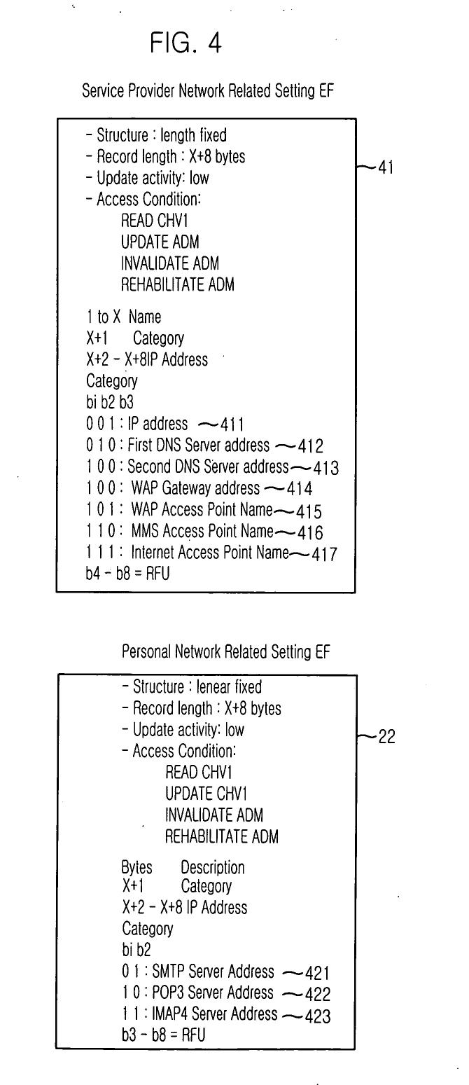

Referring to FIG. 4, included in the service provider network related set-up EF are an IP address 411, a primary Domain Name Server (DNS) 412, a secondary Domain Name Server (DNS) 413, a Wireless Application Protocol (WAP) gateway address 414, a WAP access point name 415, a Multimedia Messaging Service (MMS) access point name 416 and an Internet access point name 417. The service provider network related set-up EF stores the system network set-up information received from the mobile network.

On the other hand, at the S204, if the network set-up information is present in the smart card, the existing network set-up information stored in the smart card is matched against the system network set-up information obtained from the mobile network to look for the difference between the two pieces of information. Next, the network set-up information file is updated accordingly on the difference.

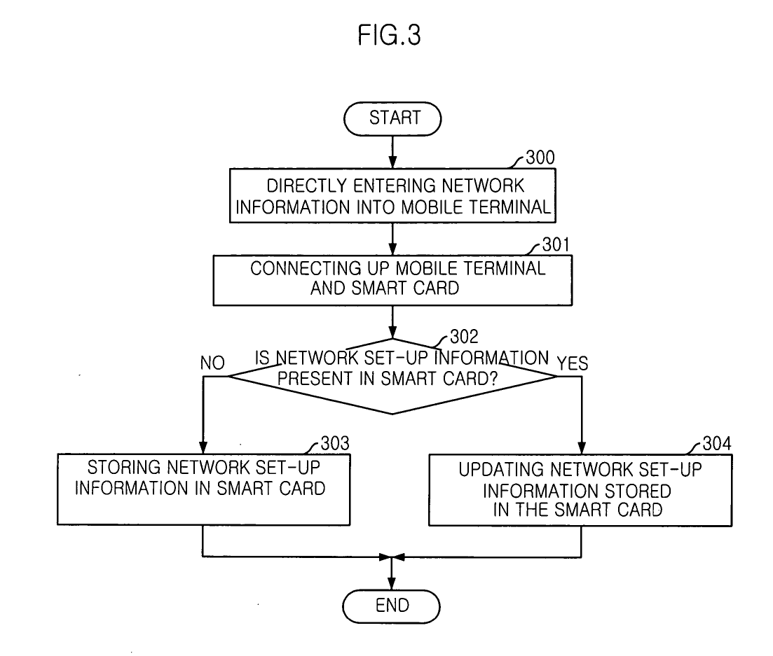

FIG. 3 is a flow chart illustrating a method for registering personal network information in a mobile terminal using a smart card in accordance with a preferred embodiment of the present invention.

At step S300, a user inputs network set-up information into a mobile terminal. At step S301, the mobile terminal connects to a smart card. At step S302, the mobile terminal determines if there exists network set-up information in the smart card. At step S303, the mobile terminal records the network set-up information in the network set-up information file, which is a predetermined storage space for storing predetermined network set-up information, in the smart card if there is no network set-up information present in the smart card.

Referring to FIG. 4, included in the personal network related set-up EF are a Simple Mail Transfer Protocol (SMTP) server address 421, Post Office Protocol version 3 (POP3) server address 422 and Internet Message Access Protocol version 4 (IMAP4) server address 423. The personal network related set-up EF keeps the personal network set-up information directly inputted by a user.

On the other hand, at the S304, if the network set-up information is present in the smart card, the existing network set-up information stored in the smart card is matched against the personal network set-up information entered by the mobile user to look for the difference between the two pieces of information. Next, the network set-up information file is updated accordingly on the difference.

The effect of the present invention as recited in the above is briefly summarized herein as follows. The network information is stored in the network set-up information file, which is a predetermined storage space for storing predetermined network set-up information, in the smart card the smart card instead of the flash memory. In this case, the existing information stored in the smart card in one mobile terminal can be easily ported to the other mobile terminal without having to set up the network information all over again when a user switches mobile terminals.

While the present invention has been described with respect to certain preferred embodiments, it will be apparent to those skilled in the art that various changes and modifications may be made without departing from the scope of the invention as defined in the following claims.

What is claimed is:

1. A method for registering network information in a mobile terminal using a smart card, the method comprising the steps of:
a) receiving system network set-up information into a mobile terminal from a wireless communication system;
b) connecting a smart card in the mobile terminal and determining if there exists network set-up information in the smart card;
c) storing the newly-acquired network set-up information in a network set-up information file stored in the smart card if there is no network set-up information present in the smart card; and
d) comparing the existing network set-up information stored in the smart card with the newly-acquired system network set-up information obtained from a wireless communication system and updating difference between the existing network set-up information and the newly-acquired system network set-up information in the network set-up information file if there is the network set-up information present in the smart card.

2. The method as recited in claim 1, wherein the network set-up information file contains a service provider network related set-up Elementary File (EF).

3. The method as recited in claim 2, wherein the service provider network related set-up EF includes an IP address, a primary domain name server, a secondary domain name server, a wireless application protocol gateway address, a wireless application protocol access point name, a multimedia messaging service access point name and an Internet access point name.

4. A method for registering network information in a mobile terminal using a smart card, the method comprising the steps of:
a) receiving personal network set-up information entered by a user;
b) connecting to a smart card and determining if there exists network set-up information in the smart card;
c) storing the newly-acquired network set-up information in the network set-up information file stored in the smart card if there is no network set-up information present in the smart card; and
d) comparing the existing network set-up information stored in the smart card with the newly-acquired personal network set-up information inputted by a user and updating differences between the existing network set-up information and the newly-acquired personal network set-up information if there is network set-up information present in the smart card.

5. The method as recited in claim 4, wherein the network set-up information file includes a personal network related set-up Elementary File (EF).

6. The method as recited in claim 5, wherein the personal network related set-up EF includes a Simple Mail Transfer Protocol server address, a Post Office Protocol version 3 server address and an Internet Message Access Protocol version 4 server address.
